(19) United States
(12) Patent Application Publication
(10) Pub. No.: US 2004/0152486 A1
(43) Pub. Date: Aug. 5, 2004

(54) Capture, edit and distribution method of image and sound information

(76) Inventor: Masaharu Sano, Hino (JP)

Correspondence Address: SANO, Masaharu, 2-27-11 Minamidaira, Hino, Tokyo, 191-0041, JP

(21) Appl. No.: 10/358,292

(22) Filed: Feb. 3, 2003

(51) Int. Cl. H04M 1/00; H04B 1/38

(52) U.S. Cl. 455/557

(57) ABSTRACT

The service method for the capture, edit and distribution of the image and sound information relating to the customer by the system comprised of the image and sound information capturing methods with various auxiliary apparatus prepared at adequate places. The maneuvering capability through the information terminal for these methods may be also provided.

Captured information are stored, edited and filed, then these filed information are retrieved, checked and selected by the customer through the information terminal for output to customers. This service method provides the output method of the information to recording media or to customer's information terminals, or the distribution methods of the information through the information communication method such as the Internet to addresses specified by customers whether these addresses locate on the moving bodies or at stationary places. The accounting procedure is made through the information terminals available to customers as necessary means of this service method.

### FEDERALLY SPONSORED RESEARCH

Not Applicable

### SEQUENCE LISTING OR PROGRAM

Not Applicable

### BACKGROUND

1. Field of Invention

This invention relates to the method of the service for the capturing, storing, edit and distribution of image and sound information that is acquired by the preinstalled system comprised of the image and sound information capturing methods with various auxiliary apparatus prepared at adequate places. The service provider displays guidance information on the information terminals available to customers such as mobile phones about services to be provided, and steps to require the service with fees etc., then the customer informs the requirement to receive particular services with customer's personal information which is necessary to the accounting procedure through an information terminal available to the customer for initiating of the first service loop by the service provider.

The captured image and sound information are displayed on information terminals available to customers including mobile phones, and stored, edited by the service provider's system for the selection in order to storing onto the output media. The service provider also prepares the methods to distribute the selected information files to the address specified by the customer through the communication methods such as the Internet.

For finalizing of the service, the service provider informs the summary list of the service provided with the amount to be charged to customers on the information terminal available to customers such as mobile phones. Then, the final accounting procedure is made, and the termination or entering to the next new service loop is made.

The recent people's life style and the variety of people's activity intimate that the opportunity to provide image and sound information for these people in action while they are not able to use their own image and sound capturing methods. Even for the people with no or almost no action, if image and sound information of the people acquired with excellent capability or from unbelievable position is provided at attractive places, and the service method for high quality data output or distribution is provided, most people admire and may require the service to output or distribute those data directly to their own information system through the information communication method such as the Internet.

Customers boarded on moving bodies like airplanes, ships, boats, yachts, trains, buses, cars or other various vehicles at a theme park such as a jet coaster etc. can enjoy the capturing of the beautiful or interesting outside scenes from the moving body and the inside of the moving body by their own image and sound information capturing means such as a camera, a video-camera etc.

If the image and sound information of the moving body itself captured from the outside of the moving body that the customer is onboard is available to display and to record onto the information terminal of the customer, it is strongly admired by the customer on board or even other customers.

Recent development of the information technology, mobile information terminals including mobile phones and of the infrastructure for the digital data communication allows the handling of huge amount of data including the moving image and sound information with other data if required. This invention is related to the service method of capturing, storing, editing and distribution of image and sound information utilizing aggressively these advanced information technology.

2. Description of Prior Art

At some points in theme parks, the service to provide paper outputs of still images of customers at specified places or customers on the moving body is available. But most of cases, the order and receiving of the output is made at almost the same place.

At some sites in the event hall or so, the service to provide display and output service of image and sound information of the montage image of the customer and artificial or non-artificial background is available.

But most of cases, the order and the reception of the output are made at almost the same place.

And recently the service to display various contents to display means on the moving body is available. Most of cases, these contents including broadcasting TV or movies or character information such as news, advertisement, guidance etc. are displayed only one-way direction.

### REFERENCES

1) U.S. patent application 20020191071 Kind Code A1 Rui, Yong et al. Dec. 19, 2002

2) Japan Patent Application 2001-37229 Nishiyama, Mika et al. Feb. 14, 2001

### OBJECTS AND ADVANTAGES

Objectives

The provision of the service method for capture, storing, edit and distribution of the image and sound information that has the following features;

The provision of the distinctive image and sound information for customers who visit places where the service provider specified and prepared with the system comprised of the image and sound information capturing means and other auxiliary apparatus.

The provision of the image and sound information for customers who cannot hold and use their own image and sound information capturing means.

Information captured by the system comprised of the image and sound information capturing means and other auxiliary apparatus prepared in the vicinity of the points where the moving body, for capturing of image and sound information of the moving body itself in still or moving status or with customers from the outside of the moving body. And also the information captured by the system comprised of the image and sound information capturing means and other auxiliary apparatus prepared on the moving body for capturing the image and sound information of customers in action or not in action, within the area on the moving body specified by the service provider, or for capturing image and sound information of various points on the moving body or varying outside scenes with or without customers. This service method is comprised of the service method for capturing, editing, output or distribution of above explained information, and also ordering and accounting service, through the information terminals available to customers.

Advantages

As this service method utilizes information terminals available to customers, the communication between customers and the service provider is maid mainly trough information terminals such as mobile phones. This allows customers to order this service anytime from any places through information terminals, and to keep in touch during the service period with the service provider, and may maneuver the image and sound information means, and to retrieve, to select the filed information, and to give direction for output or distribution such files to customer preferred media or customer specified addresses by the information communication method such as the Internet.

If customers are in action with various sporting or other type of activity, or aboard the various vehicles, machines or so, usually they cannot capture their own image information. For such customers who cannot hold and use their own image and sound information capturing means, this service method can provide so called “hands-free” service.

### BRIEF SUMMARY OF THE INVENTION

The present invention is the service method of the provision of the capturing, storing, editing and distribution of the image and sound information of the customer or related image and sound information using the system comprised of the capturing, storing, editing and distribution means with various auxiliary apparatus prepared at adequate places.

The primary objective of the present invention is the provision of the service method for capturing, storing, editing and distribution of the image and sound information, which has the following features;

(1) The guidance information announced by the service provider and the reception of orders from customers are made through information terminals available to customers such as mobile phones.

(2) The capturing service of image and sound information by the system comprised of the image and sound information capturing method and other auxiliary apparatus prepared at the adequate places by the service provider where the customers' action with surrounding scene is captured as image and sound information. The maneuvering operation of this capturing methods and auxiliary methods is made by the service provider's system or by the customer through the information terminal available to the customer.

(3) The captured image and sound information are displayed both on the information terminals prepared by the service provider and to the customer's information terminal including mobile phones, and then stored and edited by the service provider's system for further selection by the customer and for delivery to customers. The service provider prepares the output methods of the selected information filed onto selected recording or storing media including papers or the methods to deliver the selected information files to the address specified by the customer through the communication methods such as an inter-net.

(4) The method for the finalizing of the service by the service provider showing of the summary list of the service provided with information about the amount to be charged to the customer on the information terminal available to the customer. Then receiving the confirmation from the customer, the final accounting procedure is made, and the termination or entering to the next service loop is made.

(5) The provision of the service method for the displaying, storing, editing and distribution of image and sound information captured from the outside or inside of the moving body by the image and sound capturing method prepared at adequate places.

(6) The information other than image and sound information such as temperature, humidity, pressure data, camera position, direction, angles etc. are included within the image and sound information.

The additional objective of the present invention is the provision of the service method for capturing, storing, editing and distribution of the image and sound information, which has the following features;

Capturing of image and sound information, storing the captured information and edting of these information, and provision of the output service of selected information onto the customer preferred storing media, or distributing to the customer specified address or so through the information communication method such as the Internet.

In addition to the service method for the customer who moves a place to another place by walking, so called drive-through service is also provided when customers who move by car or other type of vehicles from place to place.

The service provider captures image and sound information for customers who visit a wide and huge natural park or a theme park with several entrances or exits, by the system comprised of the image and sound information capturing means, setting at a fixed point or on a moving arm or on a moving body, prepared at adequate places to capture the image and sound information of customers' action or motion within the area with related information or with natural or artificial background or with various vehicles that customers are aboard.

The alternative objective of the present invention is the provision of the service method for capturing, storing, editing and distribution of the image and sound information, which has the following features;

The service method for capturing, storing, editing, output and distribution of image and sound information as set forth in claim 1, wherein the service method featuring as follows; Providing the image and sound information capturing means prepared in the vicinity of the point where the moving body passes for capturing of image and sound information of the moving body itself in the still or moving status or with customers from the outside of the moving body.

Providing the image and sound information capturing means prepared on the moving body for capturing the image and sound information of customers in action or not within the area specified by the service provider on the moving body, or for capturing the image and sound information of various points on the moving body or varying outside scenes with or without customers.

### BRIEF DESCRIPTION OF THE DRAWINGS

The present invention can be further understood by reference to the following description and attached drawings that illustrate, by way of example, the preferred embodiment in FIG. 1, the alternative embodiment in FIG. 2 and the additional embodiment in FIG. 3. Other features and advantages will be apparent from the following detailed description of the invention in conjunction with these FIGs.

FIG. 1 illustrates the general configuration of the system comprising of image and sound information capturing system for the preferred embodiment of the present invention. This figure shows an example for a basic application of the present invention.

FIG. 2 illustrates the general configuration of the system comprising of image and sound information capturing system for the alternative embodiment of the present invention. This figure shows an example for an expanded application of the present invention.

FIG. 3 illustrates the general configuration of the system comprising of image and sound information capturing system for the additional embodiment of the present invention. This figure shows an example for an application related to the moving body of the present invention.

### REFERENCE NUMERALS IN DRAWINGS

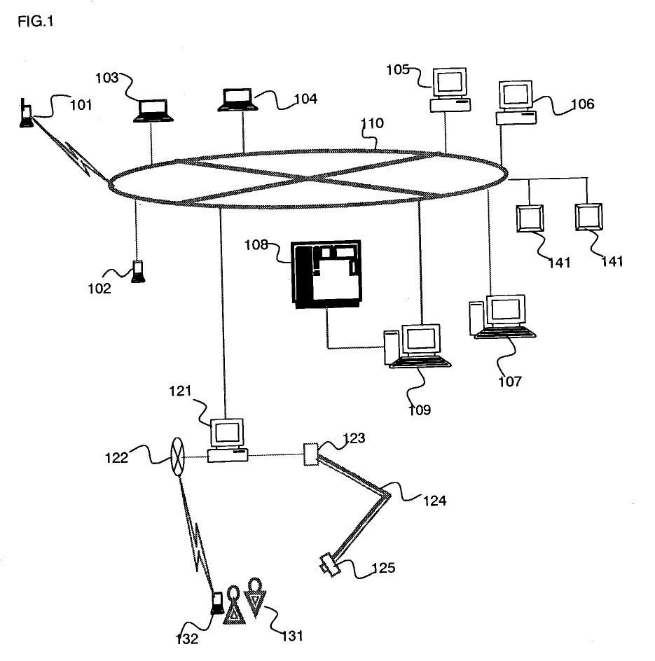

For FIG. 1

101, 102, 103, 104 Information terminal available to the customer such as mobile phones

105, 106, 107 Distributed information terminals provided by the service provider

108, 109 Service provider's server system and information terminals

110 Information communication methods such as Internet

121 Information communication methods and control method of Image and Sound Information capturing method

122 Information communication methods such as Internet

123 Image and Sound information capturing method and maneuvering method of its mounted arm

This method is connected to 121 through short distance radio communication method when it is convenient.

124 Mounting method of Image and Sound information capturing method

125 Image and Sound information capturing method

131 customer(s)

132 Information terminals available to the customer such as mobile phones

141 Display method for displaying of captured image and sound information capturing method

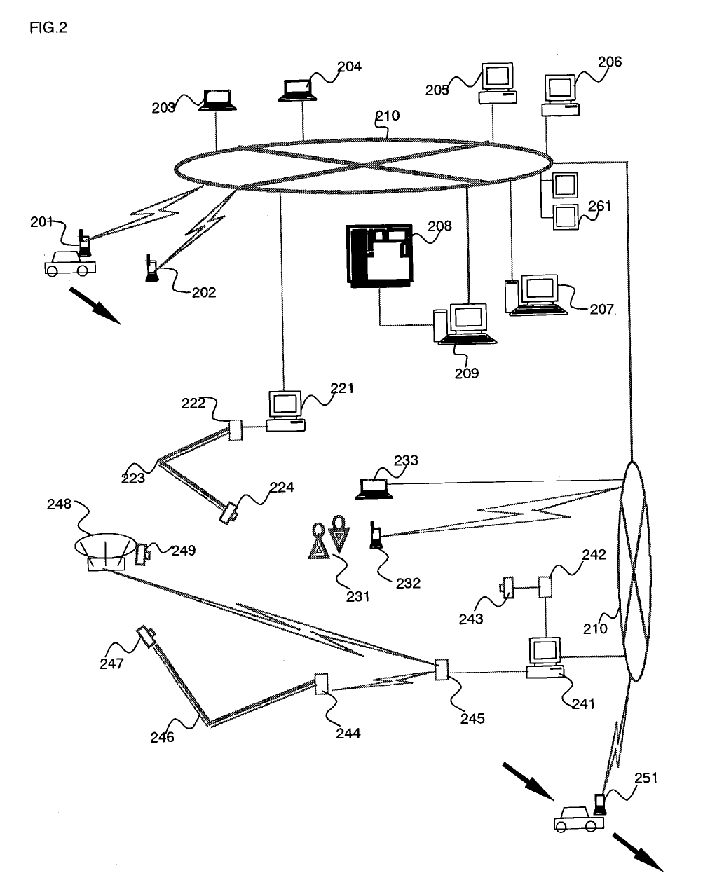

For FIG. 2

201, 202,203,204 Information terminals available to the customer such as mobile phones

205, 206,207 Distributed information terminals provided by the service provider

208, 209 Service provider's server system and information terminals

210 Information communication methods such as the Internet

221 Control methods for information communication method and image and sound capturing means

222 Image and Sound information capturing mean and maneuvering mean for the arm which it is mounted

This means may be connected to 221 through short distance radio communication Method when it is convenient.

223 Mounted method of Image and Sound information capturing method

224 Image and Sound Information Capturing mean

231 customer(s)

232, 233 Information terminals available to the customer such as mobile phones

241 integrated operating method for image and sound information capturing means

242 control method for image and sound information capturing mean

This control method may be connected to 241 through short distance radio communication method when it is convenient.

243 Image and Sound Information Capturing mean

244 maneuvering method for a holding arm for image and sound information means and information communication method

245 Information communication method

246 Mounted method of Image and Sound information capturing method

247 Image and Sound information capturing method

248 mobile type holding method for image and sound information capturing means

249 Image and Sound Information Capturing mean

251 Information terminals available to the customer such as mobile phones

261 Display method for displaying of captured image and sound information capturing method

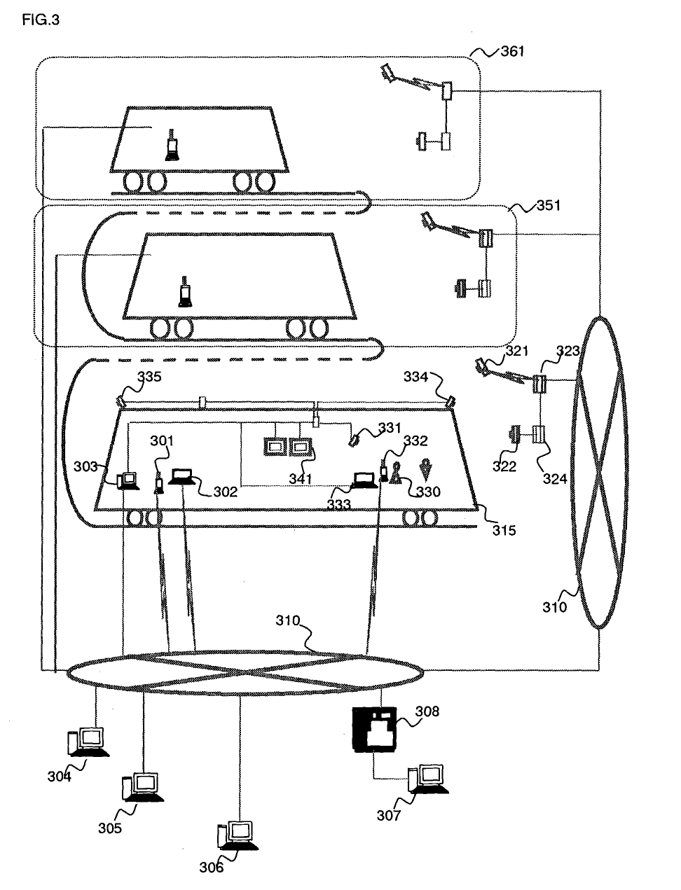

For FIG. 3

Integrated system comprised of the image and sound information capturing means at Place A

301, 302 Information terminal available to the customer such as mobile phones

303 Distributed information terminals provided by the service provider

304, 305,306 Information terminal available to the customer such as mobile phones or Distributed information terminals provided by the service provider

307, 308 Service provider's server system and information terminals

310 Information communication methods such as Internet

321, 322 Image and Sound information capturing methods

323, 324 Information communication method such as a short distance radio information communication method

331 image and sound information capturing mean prepared inside of the moving body

332, 333 image and sound information capturing means prepared outside of the moving body

341 Display mean prepared for image and sound information

351 Integrated system comprised of the image and sound information capturing means at Place B

361 Integrated system comprised of the image and sound information capturing means at Place C

### DETAILED DESCRIPTION

Description—FIG. 1—Preferred Embodiment and Operation

Referring to FIG. 1, an exemplary system and method for implementing the present invention is explained.

The service method featuring the followings is provided;

Capturing of image and sound information, storing the captured information and editing of these information, and provision of the output service of selected information onto the customer preferred storing media, or distributing to the customer specified address or so through the information communication method such as the Internet.

Image and sound information of the customers action who locates within the area provided by the service provider, with the surroundings of that area and background scene is captured by the image and sound information capturing method preinstalled at adequate places. The service provider's server system stores, edits these information and displays on the information terminals provided by the service provider or on the information terminals available to the customer such as mobile phones, and provides the method to output these information onto the recording or storing media selected by the customer. The service provider also provides the method to distribute the information to the customer specified address through the information communication method such as the Internet.

The service provider informs about the services or service including service items, their details, fares or waiting situation when the reservation is required etc. to be provided for the potential customers by mainly home page through the inter-net displaying on the information terminal available to such potential users such as mobile phones 101, 102, 103, 104 or 105, 106, 107.

The customer who understands the general idea of the services informed by the service provider sends back the customer's intention to receive the service(s) through the information terminal such as mobile phones available to the customer.

For establishing and authorizing of the customers order, the service provider requires the input of the customer's personal information such as a credit number for accounting purpose. With the acknowledgement of the information from the customer, the service provider issues an authorized number or a reservation number or so to the customer for the period of the service and starts the service loop required.

The service provider displays notice items, checking items, directions, performance of image and sound capturing methods, directions when maneuvering is able to do by the information terminal etc. on the information terminal available to the customer such as mobile phones when it is necessary.

The service provider establish the reservation for the places where the customer selected and informs to the customer through the information terminal available to the customer and guides customers to the selected places by the time to receive the service.

The service provider captures image and sound information for the customer who locates at the selected place with or without action during a certain period within the area specified by the service provider.

When the capability for maneuvering of the image and sound capturing method through the information terminal available to the customer 132 is provided and when the customer requires to do so, the customer captures the image and sound information of the customer without or with action within the area specified by the service provider, with looking the monitoring image on the information terminal that the customer holds for maneuvering image and sound information capturing.

This service method also provides the method to retrieve or to select or to edit the image and sound information from archived better files, for the customer who comes with bad weather condition or so to capture the good image and sound information at the reserved place when the customer reaches there.

The service provider informs the list of captured image and sound information files and related and available files on the information terminals available to the customer 101, 102, 103, 104 or 105, 106, 107, then the customer informs the customers selection of files and output media or specify the address to be distributed trough the information communication method such as the Internet.

Final Accounting Procedure and Termination

The method for the finalizing of the service by the service provider showing of the summary list of the service provided with the amount to be charged to the customer on the information terminal available to the customer. Then receiving the confirmation from the customer, the final accounting procedure will be made.

Then the service provider outputs the image and sound information files selected by the customer onto the customer preferred output media or outputs to the information terminal available to the customer or distribute to the customer specified address through the information communication method such as the Internet 110.

Then the termination or entering to the next service loop will be made.

Applications of this invention in the form explained above are considered as follows; Capture, store, edit and distribution service method for image and sound information at fixed or semi-fixed places where the customers can make their actions within a certain area by the system comprised of the image and sound information capturing method prepared.

For examples: Image and sound information of customers at dining or party in hotels or in restaurants or other places.

Customers' image in action or without action and sound information captured bythe system comprising of the image and sound information capturing method prepared at inside or outside of the place where the customer exists such as the observation area of towers or buildings or vehicles, the Ferris wheel and so on.

Description—FIG. 2—Additional Embodiment and Operation

Referring to FIG. 2, an exemplary system and method for implementing the present invention is explained.

The service method featuring the followings is provided;

Capturing of image and sound information, storing the captured information and editing of these information, and provision of the output service of selected information onto the customer preferred storing media, or distributing to the customer specified address or so through the information communication method such as the Internet.

In addition to the service method for the customer who moves a place to a place by walking, so called drive-through is also provided when customer can move by car or other type of vehicles.

The service provider captures image and sound information for the customer who visit a wide and huge natural park or a theme park with several entrances or exits, by means of image and sound information methods installed at adequate places to capture the image and sound information of customer's action or motion within the area with related information or with natural or artificial background or various vehicles that the customer uses, such as at vista points or at event points, set by the service provider even at a fixed point or with a moving arm or on the moving body.

The service provider informs to customers who access the guidance shown by homepage or other means about the services provided, those fares, places where the service is provided, waiting situation etc. and displays on the information terminals available to the customer such as mobile phones 201,202, 203,204 or 205, 206,207 etc.

This service is initiated by the informing customer's requirement of the service to the service provider though the information terminals available to the customer such as mobile phones. The service provider operates a processing system 208,209 for handling all necessary procedures about this service method.

For the confirmation of the requirement of the service, the customer informs necessary data for accountings by the service provider such as the customers credit number or the equivalent through menu page or so.

The customer also informs to the service provider about the services to be received or about the provisional reservation.

The service provider informs the authorized ID or the equivalent for the servicing period to the customer through the information terminal available to the customer with the data on the services selected by the customer for double check.

The customer sends back the double confirmation to the service providers system 208,209.

The service provider's concrete direction is informed to the customer through the information terminal available to the customer for providing the service selected by the customer.

According to the service provider's direction, the customer is waiting for the order to receive the service at the specified place standby by the specified time.

With receiving of the proceeding direction from the service provider, the customer 231 starts the action or movement within the specified area.

When image and sound information capturing methods prepared by the service provider 223,243,247 or 249 has the capability to maneuver the image and sound information capturing methods, the customer captures image and sound information by remote controlling those method with monitoring those information displayed on the information terminal available to the customer such as a mobile phone 232 or 233.

The customer may occasionally outputs the captured image and sound information with down loading to the customers information terminal available to the customer, or retrieves those information or edited information and selects the preferred information, then outputs to the selected memory media through information terminal available to the customer including information terminals prepared by the service provider at distributed information center or so.

The customer informs to the service provider through the information terminal available to the customer such as a mobile phone when the service received by the service provider is terminated. The service provider informs and displays the summary of given services to the customer, preview image and sound information captured with charging information on the information terminal available to the customer.

The customer informs to the service provider about the selected image and sound information and additional information to be output with the direction of the output method such as to download or to store a specified media or to distribute to he specified email address etc.

When the last is selected with the customer's reconfirmation about the charge, the service provider mail the selected information files to the customer specified address through the information communication method such as the Internet 210.

The service provider receives the customer's confirmation about the provided service items with their charging figures through the information terminal available to the customer such as a mobile phone. Then the service provider made accounting procedure for this case. The customer informs to the service provider about the selection whether the customer proceeds to the next service loop or quit from the service through the information terminal available to the customer such as a mobile phone.

For customers who have received the reservation for the service at the other place, the direction to proceed to the next service loop will be displayed on the information terminal available to the customer such as a mobile phone.

Thus, this service method covers for the case when the customer moves to a place to another place in the service providing area by walk and also for the case that customer can move in the service providing area by the car such as wide natural parks or other places. In the latter case, the customer can order to receive a service through the information terminal such as a mobile phone 201, then the customer can move to the particular place and can acquire the image and sound information, then the customer can give the direction to the service provide about the method to receive the output, including the download to the information terminal, the recording or storing to the specified media or the distribution to the customer specified address through the information terminal such as an inter-net, through the information terminal available to the customer such as a mobile phone 251. And also the accounting procedure is made. This case is so-called “Drive-through” service.

In addition to the above services, this service method also provides the service for capturing, storing, editing and distribution on image and sound information as a general information contents even if the customer is not included in the captured image and sound information.

Description—FIG. 3—Alternative Embodiment and Operation

Referring to FIG. 3, an exemplary system and method for implementing the present invention is explained.

The service method for capturing, storing, editing, output and distribution of image and sound information as set forth in claim 1, wherein the service method featuring as follows; The service provider informs about the services or service including service items, their details, fares or waiting situation when the reservation is required etc. to be provided for the potential customers by mainly home page through the inter-net displaying on the information terminal available to such potential users such as mobile phones 301, 302, 303, 332, 333 or 304, 305, 306.

The customer who understands the general idea of the services informed by the service provider sends back the customer's intention to receive the service(s) through the information terminal such as mobile phones available to the customer.

For establishing and authorizing of the customer's order, the service provider requires the input of the customer's personal information such as a credit number for accounting purpose. With the acknowledgement of the information from the customer, the service provider issues an authorized number or a reservation number or so to the customer for the period of the service and starts the service loop required.

The service provider displays notice items, checking items, directions, performance of image and sound capturing methods, directions when maneuvering is able to do by the information terminal etc. on the information terminal available to the customer such as mobile phones when it is necessary.

The service provider establish the reservation for the places where the customer selected and informs to the customer through the information terminal available to the customer and guides customers to the selected places by the time to receive the service.

The service provider captures image and sound information for the customer who locates at the selected place with or without action during a certain period within the area specified by the service provider.

The moving image of the moving body 315 from the outside of it by means of image and sound information capturing methods 321, 322 prepared at adequate nearby locations of the scheduled passing routes of the moving body,

actions of a customer 330 at a specified positions on the moving body, surroundings or backgrounds, outside scenery from the moving body, running image of the moving body are captured by the image and sound information capturing methods 331, 321, 322, 334 Or 335.

The service provider provides the real time image and sound information on the information terminals available to the customer or on the display methods 341.

When the maneuvering capability is available for the image and sound information capturing mean from the information terminal available to the customer such as a mobile phone 301, the customer 330 can capture customer's own action within the specified area and other scenes as image and sound information with monitoring of the live image on the information terminal such as a mobile phone.

The service provider provides the display of the moving image of the moving body 315 from the outside of it by means of image and sound information capturing methods 321, 322 prepared at adequate near-by locations of the scheduled passing routes of the moving body, to customers on-board of the moving body or to other possible customers.

The service provider also provides the means of the output of the information to the customer preferred recording media, or the method to download the information to the customer's information terminal and so on, or the means to distribute the information to the customer specified address through the Internet or other information communication means.

The captured image and sound information is transferred to the onboard 303 or other server systems 307, 308 of the service provider through the information communication means such as radio information communication mean or the Internet 310 and so on.

Image and sound information includes that of the customer or relating to the customer who locates the specified location, captured from outside or inside of the moving body by means of the image and sound information capturing methods 331, 334, 335 which are prepared at the selected points on the moving body.

Image and sound information includes information, with centering of the customer who locates at the specified location on the moving body, captured by the image and sound information capturing methods 331, 334, 335 installed at specified position on the moving body, or information captured by the image and sound information capturing methods 321, 322 prepared at adequate near-by locations of the scheduled passing routes of the moving body.

Provision of storing, edit and file retrieving and file selection capability.

The service provider provides the server system that processes procedures of storing the captured image and sound information, edit these information files, and retrieving these files and selection of files. Displaying of these information and of necessary pages or windows for the process are included within the server system

Provision of Output Means of the Information File

The service provider provides the information terminals 303, 304, 305 or 306 which have the capabilities of retrieving and selection of captured information, edited information or other information, and of output means of the information files to customer preferred recording media or distribute to the customer specified address through the information communication means such as the Internet.

And the service provider allocates distributed spots with these information terminals for this purpose.

Final Accounting Procedure and Termination

The method for the finalizing of the service by the service provider showing of the summary list of the service provided with the amount to be charged to the customer on the information terminal available to the customer. Then receiving the confirmation from the customer, the final accounting procedure will be made.

Then the service provider outputs the image and sound information files selected by the customer onto the customer preferred output media or outputs to the information terminal available to the customer or distribute to the customer specified address through the information communication method such as the Internet 110.

Then the termination or entering to the next service loop will be made.

I claim:

1. The service method for capture, store, edit, output and distribution of image and sound information that has the following features;
Providing the means of service initiation with giving the authorized ID for the period of the service, directions and communication, and reservation to the customer after the service provider's acknowledgement to the reply information such as service item(s) to be received and the customer's personal information for account procedure from the customer who reacted to the guidance information on the homepage which is issued by the service provider including the contents of the service to be provided, fares and others.
And providing the means of displaying the information to the display provided by the service provider or to the information terminals such as mobile phones available to customers on the moving body or at any other places.
And providing the means of maneuvering for the image and sound information capturing method by the information terminals such as mobile phones available to customers.
And further provision of the output means of the selected information onto the preferred storing media or recording methods and of the distribution means for the selected information to the customer specified address through the information communication method such as an inter-net.
And providing the means of the accounting procedure through the information terminal available to the customer for the serviced items required by the customer.

2. The service method for capturing, storing, editing, output and distribution of image and sound information as set forth in claim 1, wherein the service method featuring as follows;
Providing the image and sound information capturing means prepared in the vicinity of the point where the moving body passes for capturing of image and sound information of the moving body itself in the still or moving status or with customers from the outside of the moving body.
Providing the image and sound information capturing means prepared on the moving body for capturing the image and sound information of customers in action or not within the area specified by the service provider on the moving body, or for capturing the image and sound information of various points on the moving body or of moving outside scenes with or without customers.
